(19) United States
(12) Patent Application Publication
(10) Pub. No.: US 2017/0083686 A1
(43) Pub. Date: Mar. 23, 2017

(54) SYSTEMS AND METHODS FOR DISPENSING CONTROLLED MEDICINES

(71) Applicants: SPENCER HAWKINS, CHATTANOOGA, TN (US); MING JIANG, ALPHARETTA, GA (US)

(72) Inventors: SPENCER HAWKINS, CHATTANOOGA, TN (US); MING JIANG, ALPHARETTA, GA (US)

(21) Appl. No.: 15/368,549

(22) Filed: Dec. 2, 2016

Related U.S. Application Data
(63) Continuation-in-part of application No. 14/831,851, filed on Aug. 20, 2015.

(51) Int. Cl. G06F 19/00; G06Q 10/08

(52) U.S. Cl. CPC G06F 19/3456; G06Q 10/087

(57) ABSTRACT

Certain aspects of the present disclosure relate to a controlled medicine dispensing system. In certain embodiments, the controlled medicine dispensing system includes a controlled medicine dispensing controller having a processor and a non-transitory storage device storing an operating system and computer executable instructions. When executed by the processor, the computer executable instructions manage the controlled medicine dispensing system. The computer executable instructions include: a dispenser control module to control a dispenser locking mechanism and a controlled medicine dispensing mechanism, a notification module to notify certain concerned parties certain activities and status of the controlled medicine dispensing system, a communication interface module to communicate with a controlled medicine management system through a communication network, and a keypad user interface module to receive input from certain users including a patient, and one or more pharmacists through a keypad module, and display status of the controlled medicine dispensing system through a display module.

### CROSS-REFERENCE TO RELATED APPLICATION

This application is a continuation in part of a U.S. patent application Ser. No. 14/831,851, filed with the United States Patent and Trademark Office on Aug. 20, 2015, entitled “SYSTEMS AND METHODS FOR DISPENSING CONTROLLED MEDICINES”, by Spencer Hawkins and Ming Jiang, the disclosures of which are incorporated herein in their entireties by reference.

### FIELD

The present disclosure relates generally to medication dispensing, and more particularly to systems and methods for dispensing certain controlled medicines.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is a paradox of modern medicine that treatments which have the ability to alleviate pain and suffering hold the potential to be misused and abused. When a physician prescribes a patient a remedy, there is a certain trust and expectation that the patient will use their medication safely as prescribed. This traditional system of dispensing medications is affordable and appropriate for most patients. However, there are certain high risk groups of patients who may benefit from a different approach.

Chronic pain patients often require high doses of narcotic pain medication. When used as directed, opiate pain relievers can be a safe and effective treatment for a variety of pain conditions. According to the Center for Disease Control and Prevention, since 1999, the number of prescriptions written by physicians for opiate based pain killers has quadrupled. Over the same time period the number of overdose death rates has nearly paralleled this increase in number of prescriptions. Physicians are increasingly reluctant to prescribe opiate pain medication due to issues of dependence and abuse. Physicians that do prescribe narcotics often impose strict opiate contracts in an attempt to enforce safe medication practices, but these rules often fall short in preventing deaths from overdose.

Alternatively, psychiatrists often encounter patients with reduced insight into their own mental disorders. These patients may not fully understand the importance of their medication and the potential for misuse. For example, suicidal patients require treatment with antidepressants. Relatively safe medications such as selective serotonin reuptake inhibitors (SSRIs) are commonly indicated, but in refractory cases, tricyclic antidepressants (TCAs) may be necessary. TCAs, while effective in treating depression, carry the risk of fatal cardiac arrhythmias in the event of an overdose. It is current practice to discharge recently suicidal patients with vital medications that can unfortunately also be used for a subsequent attempt on their life. Psychiatry is also plagued with issues of medication adherence. Many patients with chronic disorders such as bipolar and dementia forget to take their medication. Concerned family members and physicians have no way of monitoring how often a loved one is taking their medication. It is desirable to have a medication dispenser that allows a patient access to high risk medications at appropriate times and dosage as directed by their physician.

Therefore, an unaddressed need exists in the art to address the aforementioned deficiencies and inadequacies.

### SUMMARY

In one aspect, the present disclosure relates to a controlled medicine dispensing controller of a controlled medicine dispensing system. In certain embodiments, the controlled medicine dispensing controller includes: a processor to manage the controlled medicine dispensing system, and a non-transitory storage device storing an operating system and computer executable instructions. When executed by the processor, the computer executable instructions manage the controlled medicine dispensing system. The computer executable instructions may include: a dispenser control module to control a dispenser locking mechanism and a controlled medicine dispensing mechanism, a notification module to notify certain concerned parties certain activities and status of the controlled medicine dispensing system, a communication interface module to communicate with a controlled medicine management system through a communication network; and a keypad user interface module to receive input from certain users including at least a patient, and one or more pharmacists through a keypad module, and display the status of the controlled medicine dispensing system through a display module.

In certain embodiments, the controlled medicine dispensing mechanism dispenses one or more controlled medicines according to a prescription by a physician of the patient prescribed through the controlled medicine management system. The dispenser locking mechanism prevents the patient from accessing the one or more controlled medicines outside of one or more predetermined time windows according to the prescription.

In certain embodiments, the keypad user interface module is configured to: receive a personal identification number (PIN) input from the patient or a pharmacist to access the controlled medicine dispensing system, authenticate, by the controlled medicine dispensing system, the patient or the pharmacist, allow the pharmacist to refill the one or more controlled medicines according to the prescription by the patient's physician, when the pharmacist is authenticated using the PIN received; and release the one or more controlled medicines to the patient through the controlled medicine dispensing mechanism during certain predetermined time windows, when the patient is authenticated using the PIN received.

In certain embodiments, when the pharmacist is authenticated to refill the one or more controlled medicines, the pharmacist uses a computer at the pharmacy to retrieve the patient's prescription from the controlled medicine management system through the communication network, unlocks the controlled medicine dispensing system to refill the one or more controlled medicines according to the patient's prescription retrieved, updates a controlled medicine inventory in the controlled medicine dispensing system, and locks the controlled medicine dispensing system.

In certain embodiments, when the patient is authenticated to retrieve the one or more controlled medicines, the controlled medicine dispensing system determines whether current time falls in one of the predetermined time windows according to the prescription. When the current time falls in one of the predetermined time windows, the controlled medicine dispensing system releases the one or more controlled medicines according to the prescription by the physician, and updates the controlled medicine inventory. When the current time does not fall in one of the predetermined time windows, the controlled medicine dispensing system records a failed attempt to retrieve the one or more controlled medicines in an activity history base and transmits related information of the failed attempt to the notification module to notify the concerned parties. The controlled medicine dispensing system may periodically review the activity history base, determine whether there are any prescription violations recorded, and notify the prescription violations to the concerned parties.

In certain embodiments, the concerned parties may include: the patient, the physician, the one or more pharmacists, one or more parents or guardians of the patient, and one or more close friends of the patient. Following events may trigger a notification to the concerned parties: one or more failed attempts to retrieve the one or more controlled medicines, one or more missed opportunities of taking the one or more controlled medicines during the predetermined time windows, one or more prescription violations recorded, the controlled medicine inventory is low, and the patient has taken a last dose of the one or more controlled medicines in the controlled medicine dispensing system.

In another aspect, the present disclosure relates to a computer-implemented method for dispensing one or more controlled medicines using a controlled medicine dispensing system. In certain embodiments, the method includes: establishing communication between the controlled medicine dispensing system and a controlled medicine management system through a communication network, registering, at the controlled medicine management system through the communication network, one or more physicians for prescribing one or more controlled medicines, and a number of users, and assigning a personal identification number (PIN) for each of the users. The users include a patient as a primary user of the controlled medicine dispensing system, and one or more pharmacists to fill or refill one or more prescriptions for the patient. In certain embodiments, the method include: receiving a personal identification number (PIN) from a user using a keypad user interface module of the controlled medicine dispensing system, authenticating, by the controlled medicine dispensing system, the user using the PIN received, and determining whether the authenticated user is the patient or a pharmacist.

In certain embodiments, when the pharmacist is authenticated, the method includes: retrieving, by the pharmacist using a computer at a pharmacy, the one or more prescriptions for the patient by one of the one or more physicians from the controlled medicine management system through the communication network, unlocking, by the pharmacist, the controlled medicine dispensing system, filling/refilling, by the pharmacist, the one or more controlled medicines into the controlled medicine dispensing system according to the prescription retrieved, updating, by the pharmacist, a controlled medicine inventory of the one or more controlled medicines of the controlled medicine dispensing system, and locking, by the pharmacist, the controlled medicine dispensing system when the refill is completed.

In certain embodiments, when the patient is authenticated, the method includes: determining, by the controlled medicine dispensing system, whether the current time falls into one of predetermined time windows for the patient to take the one or more controlled medicines according to the prescription. When the current time does not fall into one of the predetermined time windows for the patient to take the one or more controlled medicines, the method includes: providing, by the controlled medicine dispensing system, no controlled medicine to the patient. When the current time falls into one of the predetermined time windows for the patient to take the one or more controlled medicines according to the prescription, the method includes: providing a dose of the one or more controlled medicines, and updating, by the controlled medicine dispensing system, a controlled medicine inventory of the one or more controlled medicines of the controlled medicine dispensing system.

In certain embodiments, the method further includes: monitoring the controlled medicine inventory. In certain embodiments, monitoring the controlled medicine inventory includes: recording, by the controlled medicine dispensing system, each failed attempt to retrieve the one or more controlled medicines in an activity history base when the user attempts to retrieve the one or more controlled medicines outside of one of the predetermined time windows, transmitting, by the controlled medicine dispensing system, related information of the failed attempt to a notification module to notify certain concerned parties, reviewing, by the controlled medicine dispensing system periodically, the activity history base and determining whether there are any prescription violations recorded, and notifying the prescription violations to the concerned parties.

In yet another aspect, the present disclosure relates to a non-transitory storage device storing computer-executable instructions. When the computer-executable instructions are executed by a processor of a controlled medicine dispensing controller of a controlled medicine dispensing system, the computer-executable instructions cause the processor to perform a method of dispensing one or more controlled medicines.

In certain embodiments, the method includes: establishing communication between the controlled medicine dispensing system and a controlled medicine management system through a communication network, registering, at the controlled medicine management system through the communication network, one or more physicians for prescribing one or more controlled medicines, and a number of users, and assigning a personal identification number (PIN) for each of the users. The users include a patient as a primary user of the controlled medicine dispensing system, and one or more pharmacists to fill or refill one or more prescriptions for the patient. In certain embodiments, the method include: receiving a PIN from a user using a keypad user interface module of the controlled medicine dispensing system, authenticating, by the controlled medicine dispensing system, the user using the PIN received, and determining whether the authenticated user is the patient or a pharmacist.

In certain embodiments, when the pharmacist is authenticated, the method includes: retrieving, by the pharmacist using a computer at a pharmacy, the one or more prescriptions for the patient by one of the one or more physicians from the controlled medicine management system through the communication network, unlocking, by the pharmacist, the controlled medicine dispensing system, filling/refilling, by the pharmacist, the one or more controlled medicines into the controlled medicine dispensing system according to the prescription retrieved, updating, by the pharmacist, a controlled medicine inventory of the one or more controlled medicines of the controlled medicine dispensing system, and locking, by the pharmacist, the controlled medicine dispensing system when the refill is completed.

In certain embodiments, when the patient is authenticated, the method includes: determining, by the controlled medicine dispensing system, whether the current time falls into one of predetermined time windows for the patient to take the one or more controlled medicines according to the prescription. When the current time does not fall into one of the predetermined time windows for the patient to take the one or more controlled medicines, the method includes: providing, by the controlled medicine dispensing system, no controlled medicine to the patient. When the current time falls into one of the predetermined time windows for the patient to take the one or more controlled medicines according to the prescription, the method includes: providing a dose of the one or more controlled medicines, and updating, by the controlled medicine dispensing system, a controlled medicine inventory of the one or more controlled medicines of the controlled medicine dispensing system.

In certain embodiments, the method further includes: monitoring the controlled medicine inventory. In certain embodiments, monitoring the controlled medicine inventory includes: recording, by the controlled medicine dispensing system, each failed attempt to retrieve the one or more controlled medicines in an activity history base when the user attempts to retrieve the one or more controlled medicines outside of one of the predetermined time windows, transmitting, by the controlled medicine dispensing system, related information of the failed attempt to a notification module to notify certain concerned parties, reviewing, by the controlled medicine dispensing system periodically, the activity history base and determining whether there are any prescription violations recorded, and notifying the prescription violations to the concerned parties.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings FIGS. 1-5. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment, and wherein:

FIG. 1 is a perspective view of a controlled medicine dispensing system according to certain embodiments of the present disclosure;

FIG. 2 is a top view of the controlled medicine dispensing system according to certain embodiments of the present disclosure;

FIG. 3 shows a block diagram of a controlled medicine dispensing controller of the controlled medicine dispensing system according to certain embodiments of the present disclosure;

FIG. 4 shows a flowchart of the operation of the controlled medicine dispensing system according to certain embodiments of the present disclosure; and

FIG. 5 shows a flowchart showing detailed operation of monitoring controlled medicines inventory of the controlled medicine dispensing system according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, the term “controlled medicine” may refer to any kind of medicine prescribed by a physician, and accidental overdose of which may cause death, or serious harm to a patient.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refer to a hardware electronic component, and may refer to or include a small electronic circuit unit, also known as an integrated circuit (IC), or a combination of electronic circuits or ICs.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

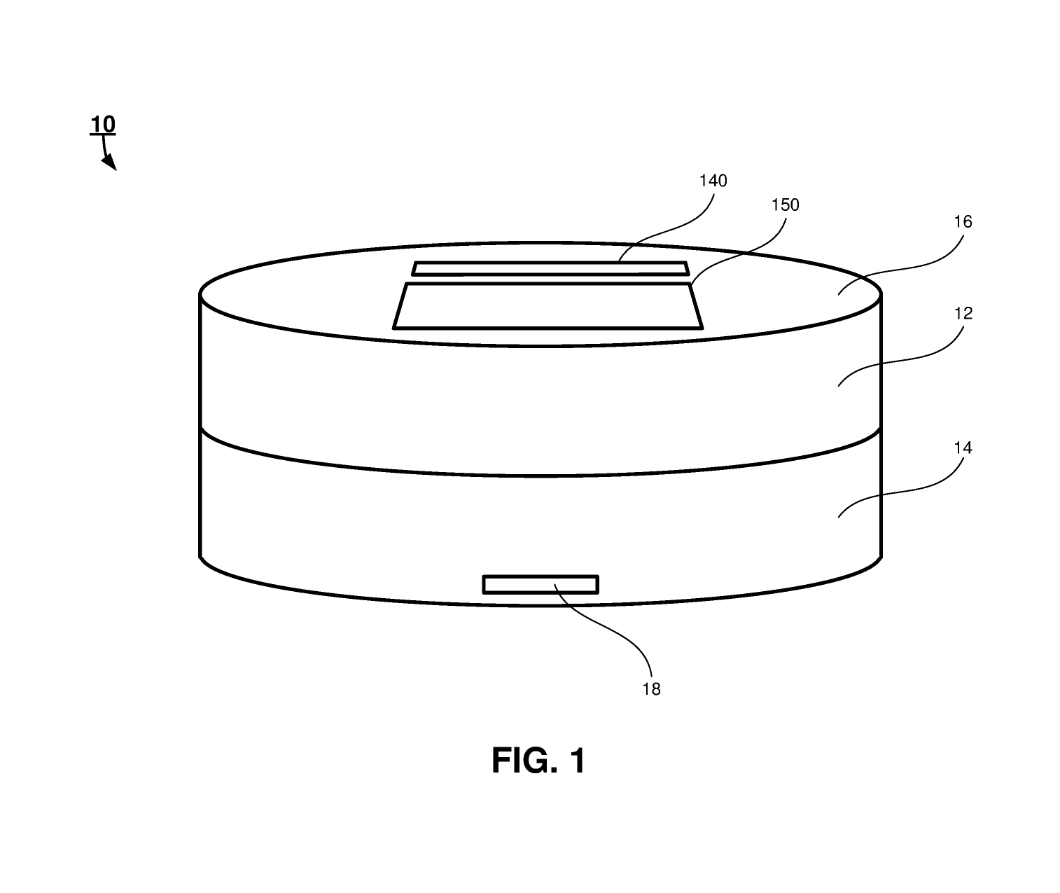

The present disclosure will now be described more fully hereinafter with reference to the accompanying drawings, FIGS. 1-5, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

In one aspect, the present disclosure relates to a controlled medicine dispensing system 10 according to certain embodiments of the present disclosure, as shown in FIG. 1. In certain embodiments, the controlled medicine dispensing system 10 has: a top cylindrical container body 12, and a lower cylindrical container body 14. The top cylindrical container body 12 has a closed top end 16, and an open bottom end (not shown). The lower cylindrical container body 14 has an open top end (not shown) that is locakably connected to the open lower end of the top cylindrical container body 12, and a closed bottom end (not shown). The lower cylindrical container body 14 also includes a medicine outlet 18 to allow a patient to receive one or more controlled medicines. The connected top cylindrical container body 12 and the lower cylindrical container body 14 form a controlled medicine dispensing system body.

In one embodiment, the top cylindrical container body 12, and the lower cylindrical container body 14 may contain a coating designed for prescription labels to be stuck on and removed easily. In another embodiment, prescription labels may be displayed on an optional touch screen display of the controlled medicine dispensing system 10, and the prescription labels may be updated electronically. In yet another embodiment, an organic light emitting diode (OLED) that can be bent to fit on curved surface may be utilized to display the prescription labels on the side of the body of the controlled medicine dispensing system 10. Such prescription labels may also be updated electronically.

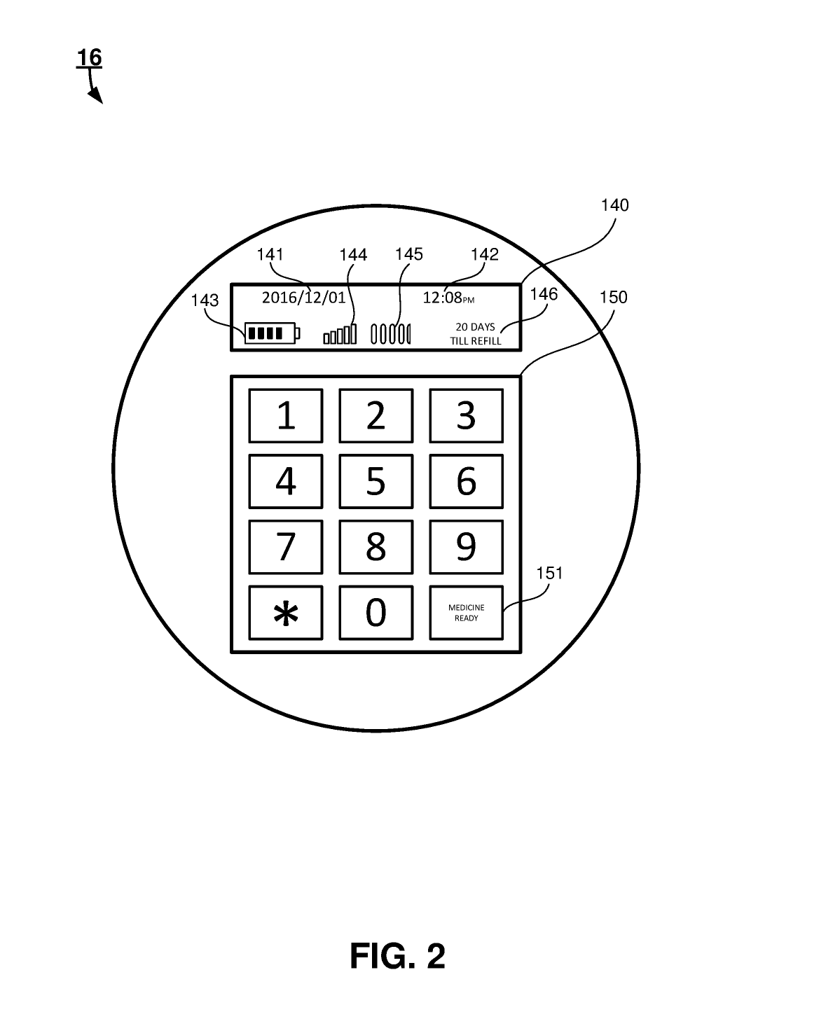

Referring now to FIG. 2, a top view of the controlled medicine dispensing system 10 is shown according to certain embodiments of the present disclosure. The closed top end 16 includes a display module 140 and a keypad module 150. The keypad module 150 is configured to receive input from at least one patient, and one or more pharmacists, and the display module 140 is configured to display the status of the controlled medicine dispensing system 10 through a display module 140. In certain embodiments, as shown in FIG. 2, the display module 140 displays a current date display 141, a current time display 142, a current battery status indicator 143, a signal strength indicator 144, a graphical controlled medicine inventory indicator 145, and a refill indicator 146. In certain embodiments, the keypad module 150 may include 0-9 digits key, a star key and a medicine ready key 151.

In certain embodiments, when the controlled medicine inventory is not empty as shown in the graphical controlled medicine inventory indicator 145 and/or the refill indicator 146, and when the current time falls into one of several predetermined time windows when the patient is allowed to take the controlled medicines, the medicine ready key 151 may be illuminated with a green light so the patient can use the keypad to enter a personal identification number (PIN) to retrieve the controlled medicines. At this time, the patient may press the 0-9 numerical key to enter his/her PIN, and press the medicine ready key 151 to retrieve the controlled medicines. When the controlled medicine inventory is empty, or when the current time does not fall into one of several predetermined time windows when the patient is allowed to take the controlled medicines, the medicine ready key 151 may be illuminated with a red light so the patient is aware that it is not the appropriate time to retrieve the controlled medicines. If the patient presses the keypad to enter his/her PIN, and attempt to retrieve the controlled medicines, this will count as a failed attempt to retrieve the controlled medicines outside of the predetermined time windows permitted. Such failed attempt represents a prescription violation and such prescription violation may be notified by the controlled medicine dispensing system 10 to certain concerned parties of the patent.

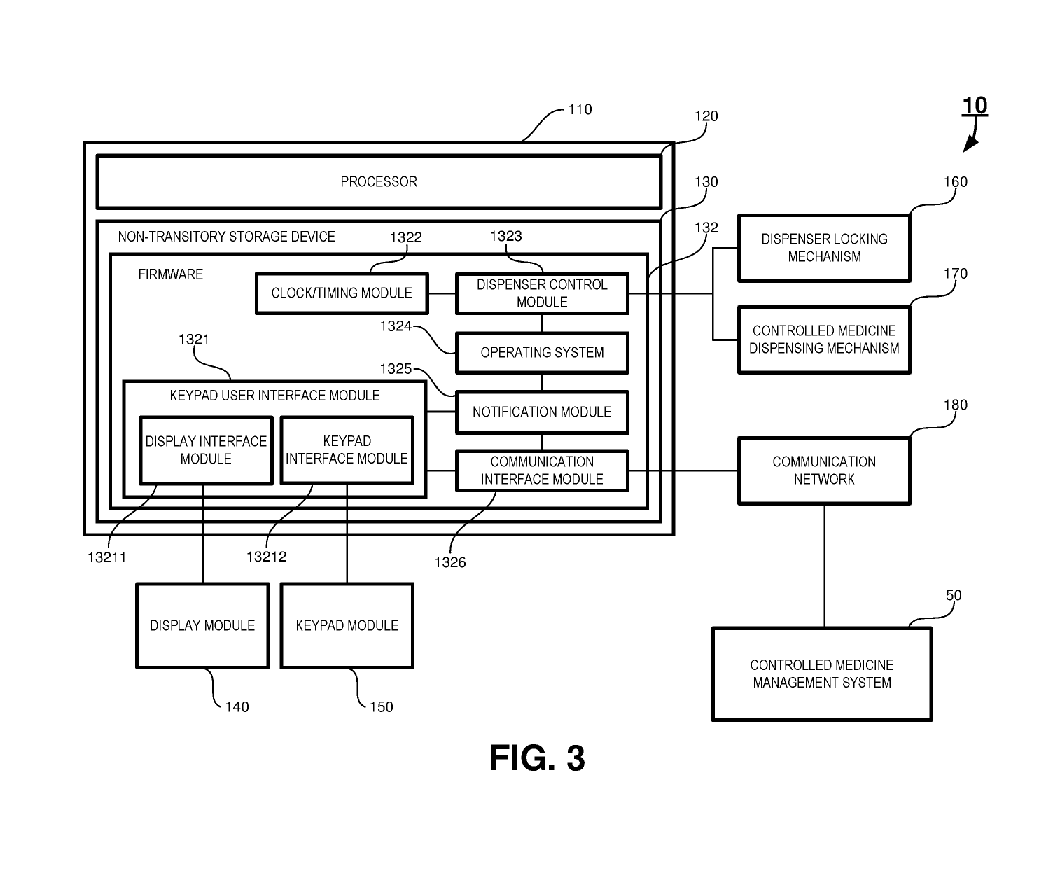

Referring now to FIG. 3, a block diagram of a controlled medicine dispensing controller 110 of the controlled medicine dispensing system 10 is shown according to certain embodiments of the present disclosure. In certain embodiments, the controlled medicine dispensing controller 110 includes: a processor 120 to manage the controlled medicine dispensing system 10, and a non-transitory storage device 130 storing an operating system 1324 and computer executable instructions. When executed by the processor 120, the computer executable instructions manage the controlled medicine dispensing system 10. The computer executable instructions may include: a dispenser control module 1323 to control a dispenser locking mechanism 160 and a controlled medicine dispensing mechanism 170, a notification module 1325 to notify certain concerned parties certain activities and status of the controlled medicine dispensing system 10, a communication interface module 1326 to communicate with a controlled medicine management system 50 through a communication network 180; and a keypad user interface module 1321 to receive input from certain users through the keypad module 150, and to display the status of the controlled medicine dispensing system 10 through the display module 140. The certain users include: at least a patient, and one or more pharmacists. In certain embodiments, the keypad user interface module 1321 interacts with the display module 140 through a display interface module 13211, and interacts with the keypad module 150 through a keypad interface module 13212.

In certain embodiments, the dispenser locking mechanism 160 includes two or more pairs of matching blocks, and a motorized locking mechanism. Each pair of the matching blocks includes a first block positioned at the open bottom end of the top cylindrical container body 12, having a first hole near the center of the first block, and a second block positioned at the open top end of the lower cylindrical container body 14, having a second hole near the center of the second block. The two or more pairs of the matching blocks are positioned substantially equal distance from each other. When the open bottom end of the top cylindrical container body 12 is placed on the open top end of the lower cylindrical container body 14, and the top cylindrical container body 12 is turned about 10 to 15 degrees, a first block at the open bottom end of the top cylindrical container body 12 will be placed under a corresponding second block at the open top end of the lower cylindrical container body 14. In one embodiment, the locking mechanism includes one motorized locking pin to be inserted into the first hole of the first block and the second hole of the corresponding second block. In another embodiments, the locking mechanism includes one motorized locking pin for each of the two or more pairs of matching blocks to be inserted into each of the first hole of the first block and the second hole of the corresponding second block, respectively. The one or more motorized pins prevent the rotation of the top cylindrical container body 12, i.e., moving horizontally, and the placement of the first block under the second block prevent the top cylindrical container body 12 moving vertically, therefore, locking the controlled medicine dispensing system body.

In certain embodiments, the controlled medicine dispensing mechanism 170 is designed according to the capacity of the controlled medicine dispensing system 10, and actual size of the controlled medicine to be dispensed. The controlled medicine dispensing mechanism 170 includes one or more layers of motorized carousel shaped medicine dispensing assembly. According to Food and Drug Administration (FDA) regulations, prescriptions for controlled medicines in Schedules 2, 3 and 4 are valid for only 28 days. Therefore, in one embodiment, the capacity of the controlled medicine dispensing system 10 is for a prescription for 4 weeks (28 days) or 30 days and three times a day. In another embodiment, the capacity of the controlled medicine dispensing system 10 is for a prescription for 2 weeks (14 days) and twice a day. In yet another embodiment, the controlled medicine dispensing mechanism 170 is flexibly configured to dispense controlled medicine for a prescription up to four weeks (28 days) and four times a day. In this embodiment, the controlled medicine dispensing mechanism 170 includes two layers of the motorized carousel shaped medicine dispensing assemblies, each layer of the motorized carousel shaped medicine dispensing assembly includes 14 individual compartments, one for each day. Each of the 14 individual compartments is divided into four different sub compartments, one for each dose of the day. Each sub compartment is filled with one dose of the controlled medicine. The motorized carousel shaped medicine dispensing assembly rotates approximately 26 degrees each day to provide controlled medicine of the day. Each individual compartment has at least three sub compartment dividers, each of them can be individually controlled. The bottom of the individual compartment may be formed such that the inside of the individual compartment is higher than the outside of the individual compartment, and once the sub compartment divider is lifted, the controlled medicine can be dispensed by its gravity.

In another embodiment, where the controlled medicine dispensing system body has the top rectangular container body 12 and the lower rectangular container body 14, the controlled medicine dispensing mechanism 170 is configured in a matrix form having a total of 30×4=120 individual compartments. The bottom of each of the individual compartment includes an individually controllable panel. When the controlled medicine in a particular individual compartment is scheduled to be released to a patient, the individual controllable panel of the particular individual compartment is open and the controlled medicine in the individual compartment is therefore released to the patient. Other configurations of the controlled medicine dispensing mechanism 170 are also possible and will not be discussed here in detail.

In certain embodiments, the controlled medicine dispensing system 10 also includes a power source, a power switch 12, and at least one operation status indicator 14. In certain embodiment, the power source includes a household electricity, battery, and rechargeable battery. In one embodiment, the power source is a combination of household electricity, battery, and rechargeable battery. When the controlled medicine dispensing system 10 is used at the patient's home, it may be plugged into the wall electric outlet. When the controlled medicine dispensing system 10 is brought to the pharmacy for refill, it uses the battery or rechargeable battery inside as power source. The power switch 12 controls the power to the controlled medicine dispensing system 10. A current battery status indicator 143 of a display module 140 of the controlled medicine dispensing system 10 displays the current battery status of the controlled medicine dispensing system 10. A signal strength indicator 144 of the display module 140 of the controlled medicine dispensing system 10 displays the signal strength of the communication network of the controlled medicine dispensing system 10.

In certain embodiments, the controlled medicine dispensing mechanism 170 dispenses one or more controlled medicines according to a prescription by a physician of the patient prescribed through the controlled medicine management system 50. The dispenser locking mechanism 160 prevents the patient from accessing the one or more controlled medicines outside of certain predetermined time windows according to the prescription.

In certain embodiments, the keypad user interface module 1321 is configured to: receive a PIN input from the patient or a pharmacist to access the controlled medicine dispensing system 10, authenticate, by the controlled medicine dispensing system 10, the patient or the pharmacist, allow the pharmacist to fill or refill the one or more controlled medicines according to the prescription by the patient's physician, when the pharmacist is authenticated using the PIN received, and release the one or more controlled medicines to the patient through the controlled medicine dispensing mechanism during certain predetermined time windows, when the patient is authenticated using the PIN received.

In certain embodiments, when the pharmacist is authenticated to refill the one or more controlled medicines, the pharmacist uses a computer at the pharmacy to retrieve the patient's prescription from the controlled medicine management system 50 through the communication network 180, unlocks the controlled medicine dispensing system 10 to refill the one or more controlled medicines according to the patient's prescription retrieved, updates a controlled medicine inventory in the controlled medicine dispensing system 10, and locks the controlled medicine dispensing system 10.

In certain embodiments, when the patient is authenticated to retrieve the one or more controlled medicines, the controlled medicine dispensing system 10 determines whether current time falls in one of the predetermined time windows according to the prescription. When the current time falls in one of the plurality of predetermined time windows, the controlled medicine dispensing system 10 releases the one or more controlled medicines according to the prescription by the physician, and updates the controlled medicine inventory. When the current time does not fall in one of the predetermined time windows, the controlled medicine dispensing system 10 records a failed attempt to retrieve the one or more controlled medicines in an activity history base and transmits related information of the failed attempt to the notification module 1325 to notify the plurality of concerned parties. The controlled medicine dispensing system 10 may periodically review the activity history base, determine whether there are any prescription violations recorded, and notify the prescription violations to the concerned parties.

In certain embodiments, the concerned parties may include: the patient, the physician, the one or more pharmacists, one or more parents or guardians of the patient, and one or more close friends of the patient. These concerned parties may be registered and configured at the controlled medicine management system 50 with the patient's consent. Following events may trigger a notification to the concerned parties: one or more failed attempts to retrieve the one or more controlled medicines, one or more missed opportunities of taking the one or more controlled medicines during the predetermined time windows, one or more prescription violations recorded, the activity history base, the controlled medicine inventory, and the patient has taken a last dose of the one or more controlled medicines.

In one embodiment, the concerned parties may be notified for certain events with the knowledge of the patient. In another embodiment, the concerned parties may be notified for certain events without the knowledge of the patient.

In certain embodiments, the notification to the concerned parties may include: one or more emails, one or more automatic phone calls, one or more text messages, one or more WeChat messages, one or more Facebook messengers, one or more WhatsApp messages, and other instant messages applications.

In certain embodiments, the communication network 180 may include: the internet, a Wi-Fi network, a local area network (LAN), a wide area network (WAN), a personal area network (PAN) having wireless universal serial bus (USB), Bluetooth, Zigbee, Body Area Network (BAN), and Near Field Communication (NFC) network, a wireless communication network, and a land line communication network.

In certain embodiments, the controlled medicine dispensing system 10 may be used by the patient without the connection to the communication network 180. Therefore, when the patient does not have internet connection, wireless communication network, or the Wi-Fi network at home, the controlled medicine dispensing system 10 may be used as a stand-alone unit that does not have connection to the communication network 180. In this case, when the patient is notified, through the display module 140 that the last dose has been dispensed and the controlled medicines must be refilled, the patient has to take the controlled medicine dispensing system 10 to a designated pharmacy to refill. The pharmacist at the pharmacy may connect the controlled medicine dispensing system 10 through a USB interface to the computer that has the connection to the communication network 180 to refill the one or more controlled medicines.

In certain embodiments, the controlled medicine dispensing controller 110 may include a clock/timing module 1322 to maintain current date and time. The display module 140 receives date and time information from the clock/timing module 1322. The controlled medicine dispensing controller 110 may be powered by a number of batteries, a number of rechargeable batteries, or a wall plug from an AC power outlet. In certain embodiments, when batteries or rechargeable batteries are used, the operating system 1324 of controlled medicine dispensing controller 110 may monitor a battery usage and report the current battery status to the keypad user interface module 1321 for displaying on the display module 140. The current battery status indicator 143 of the display module 140 displays the current battery status of the controlled medicine dispensing system 10.

In certain embodiments, when the communication network 180 is connected through a Wi-Fi network, a wireless communication network, a Wi-Fi hotspot, the operating system 1324 of controlled medicine dispensing controller 110 may monitor a signal strength of the communication network 180 and report the signal strength to the keypad user interface module 1321 for displaying on the display module 140. The signal strength indicator 144 of the display module 140 displays the signal strength of the communication network of the controlled medicine dispensing system 10.

In certain embodiments, the graphical controlled medicine inventory indicator 145 and the refill indicator 146 receive controlled medicine inventory information through the notification module 1325 of the controlled medicine dispensing controller 110 of the controlled medicine dispensing system 10, and calculates the remaining does and display graphically through the graphical controlled medicine inventory indicator 145, and also displays how many days remain until next refill.

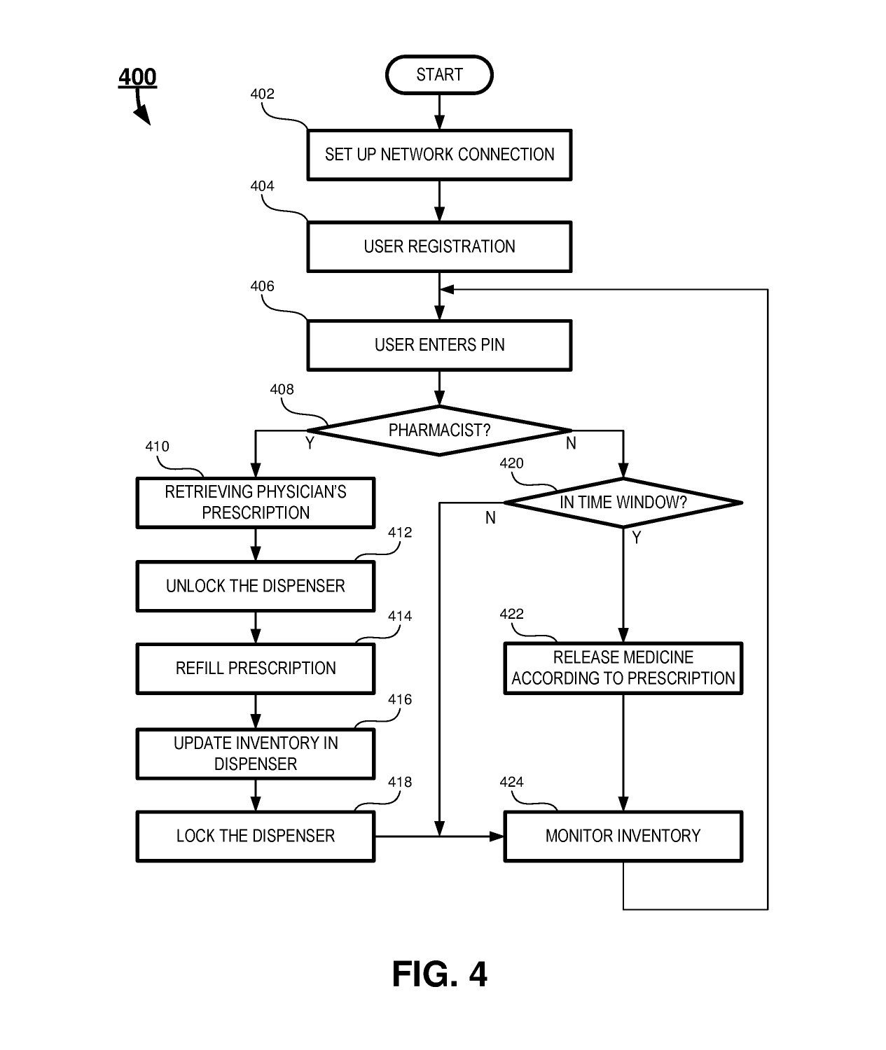

In another aspect, the present disclosure relates to a computer-implemented method for dispensing one or more controlled medicines using a controlled medicine dispensing system 10. Referring now to FIG. 4, a flowchart 400 of the operation of the controlled medicine dispensing system 10 is shown according to certain embodiments of the present disclosure. In certain embodiments, the controlled medicine dispensing controller 110 of the controlled medicine dispensing system 10 is installed inside of the controlled medicine dispensing system body. The controlled medicine dispensing controller 110 is programmed to perform the computer-implemented method for dispensing one or more controlled medicines.

At block 402, the controlled medicine dispensing system 10 establishes communication between the controlled medicine dispensing system 10 and a controlled medicine management system 50 through a communication network 180.

At block 404, a user uses a computer connected through the communication network 180 and registers one or more physicians for prescribing one or more controlled medicines, and a number of users at the controlled medicine management system 50, and assigning a personal identification number (PIN) for each of the users. The users include a patient as a primary user of the controlled medicine dispensing system 10, and one or more pharmacists to fill or refill one or more prescriptions for the patient. The PINs for the pharmacists is used to open the controlled medicine dispensing system 10 and fill or refill the prescriptions by the one or more physicians. The PIN for the patient is used by the patient to retrieve the one or more controlled medicines according to the prescriptions from the physicians at a number of predetermined time windows.

At block 406, a user enters the PIN for the user using a keypad user interface module 1321 of the controlled medicine dispensing system 10. The controlled medicine dispensing system 10 authenticates the user using the PIN received. Then the authenticated user accesses the controlled medicine dispensing system 10. The authenticated pharmacist accesses the controlled medicine dispensing system 10 to fill or refill, and the authenticated patient accesses the controlled medicine dispensing system 10 to retrieve the one or more controlled medicine.

At the query block 408, the controlled medicine dispensing system 10 determines whether the user is the patient or the pharmacist based on the PIN number entered. When the user is the pharmacist, the method proceeds to block 410, and when the user is the patient, the method proceeds to block 420.

At block 410, when the user is the pharmacist, the pharmacist retrieves the prescription of the one or more controlled medicines from the prescribing physician using a computer at a pharmacy through the communication network 180.

At block 412, the controlled medicine dispensing system 10 is unlocked by the PIN of the pharmacist.

At block 414, the pharmacist fills or refills the prescription according to the prescription retrieved.

At block 416, the pharmacist updates a controlled medicine inventory in the controlled medicine dispensing system 10 using one or more buttons inside the controlled medicine dispensing system 10. In one embodiment, the controlled medicine inventory may be updated by certain sensors installed in the controlled medicine dispensing system 10 to detect the presence of the pills of the controlled medicines. In another embodiment, the controlled medicine inventory may be updated manually.

At block 418, the pharmacist closes and locks the controlled medicine dispensing system 10. The updated controlled medicine inventory is transmitted to block 424 for monitoring the controlled medicine inventory.

At block 420, when the patient is authenticated, the controlled medicine dispensing system 10 determines whether the current time falls in one of the predetermined time windows when the patient is permitted to take the controlled medicines. The method proceeds to block 422 when the current time falls in one of the predetermined time windows when the patient is permitted to take the controlled medicines, and proceeds to block 424 when the current time does not fall in one of the predetermined time windows when the patient is permitted to take the controlled medicines.

At block 422, when the current time falls in one of the predetermined time windows when the patient is permitted to take the controlled medicines, the controlled medicine dispensing system 10 release the one or more controlled medicines according to the prescription to the patient. When the current time does not fall in one of the predetermined time windows when the patient is permitted to take the controlled medicines, the controlled medicine dispensing system 10 skips the block 422 and does not release the one or more controlled medicines according to the prescription to the patient.

At block 424, the controlled medicine dispensing system 10 monitors the controlled medicine inventory. Once monitoring the controlled medicine inventory is completed, the method proceeds back to block 406 waiting for a user to enter the PIN.

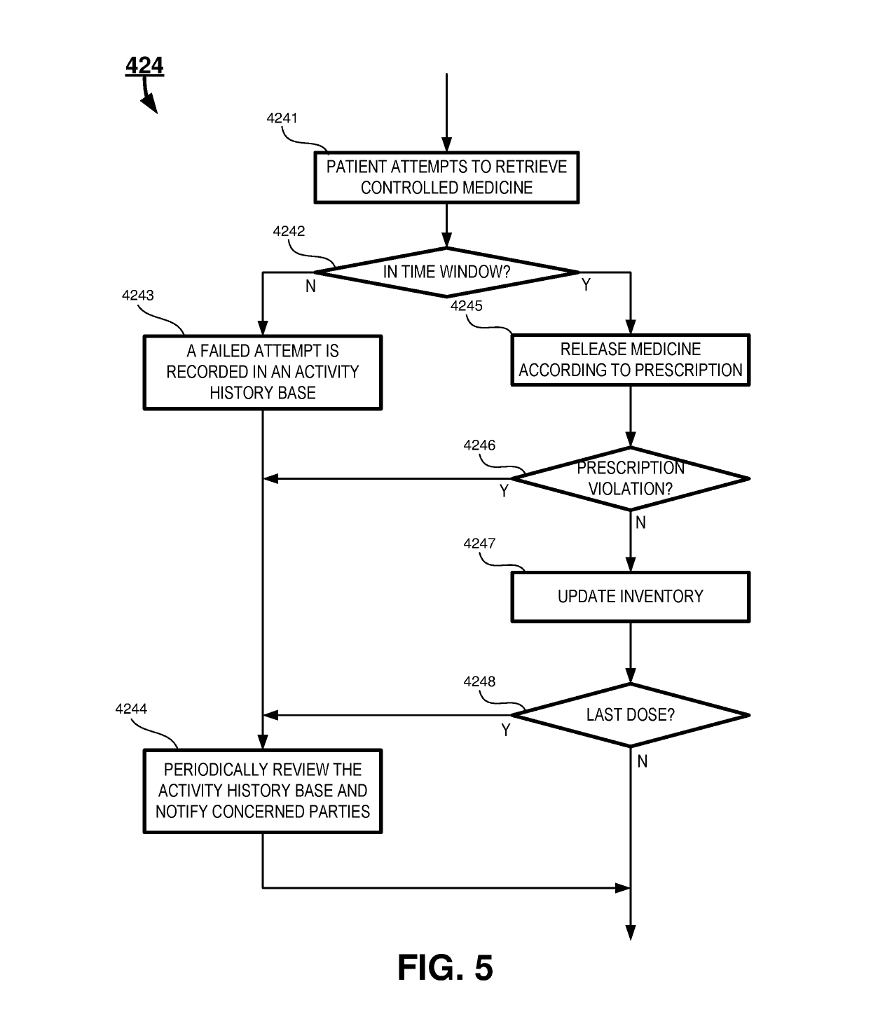

Referring now to FIG. 5, the block 424 is shown in detail of the operation of monitoring the controlled medicine inventory according to certain embodiments of the present disclosure.

At block 4241, the patient attempts to retrieve the controlled medicines by entering his/her PIN.

At query block 4242, the controlled medicine dispensing system 10 determines whether the current time falls in one of the predetermined time windows when the patient is permitted to take the controlled medicines. When the current time falls in one of the predetermined time windows when the patient is permitted to take the controlled medicines, the method proceeds to block 4245. When the current time does not fall in one of the predetermined time windows when the patient is permitted to take the controlled medicines, the method proceeds to block 4243.

At block 4243, the controlled medicine dispensing system 10 records a failed attempt to retrieve the controlled medicine in an activity history base as a prescription violation. Other event such as one or more missed opportunities of taking the one or more controlled medicines during the predetermined time windows, the controlled medicine inventory is low may also be recorded in the activity history base.

At block 4244, the controlled medicine dispensing system 10 periodically review the activity history base to find any events that may trigger a notification to certain concerned parties. If the one or more events are found in the activity history base, the controlled medicine dispensing system 10 uses a notification module to notify the concerned parties. Once the block 4244 is completed, the method proceeds to exit from the block 424.

At block 4245, when the current time falls in one of the predetermined time windows when the patient is permitted to take the controlled medicines, the controlled medicine dispensing system 10 releases the controlled medicines to the patient according to the prescription. This release controlled medicine events is also recorded in the activity history base.

At query block 4246, the controlled medicine dispensing system 10 checks the activity history base to determine whether there is any prescription violation. When there are any prescription violations, the method proceeds to block 4244. Otherwise, the method proceeds to block 4247.

At block 4247, the controlled medicine dispensing system 10 updates the controlled medicine inventory after the release of the controlled medicine.

At query block 4248, the controlled medicine dispensing system 10 determines whether the controlled medicine inventory is low or the patient has taken the last dose of the one or more controlled medicines in the controlled medicine dispensing system 10. When the patient has taken the last dose of the one or more controlled medicines in the controlled medicine dispensing system 10, the method proceeds to block 4244 for notification. Otherwise, the method proceeds to exit from the block 424.

In yet another aspect, the present invention relates to a non-transitory computer storage medium storing computer-executable instructions stored. When the computer-executable instructions are executed by a processor 120 of a controlled medicine dispensing controller 110 of a controlled medicine dispensing system 10, the computer-executable instructions cause the processor 120 to perform a method of dispensing one or more controlled medicines.

In certain embodiments, the method includes: establishing communication between the controlled medicine dispensing system 10 and a controlled medicine management system 50 through a communication network 180, registering, at the controlled medicine management system 50 through the communication network 180, one or more physicians for prescribing one or more controlled medicines, and a number of users, and assigning a personal identification number (PIN) for each of the users. The users include a patient as a primary user of the controlled medicine dispensing system 10, and one or more pharmacists to fill or refill one or more prescriptions for the patient. In certain embodiments, the method include: receiving a personal identification number (PIN) from a user using a keypad user interface module 1321 of the controlled medicine dispensing system 10, authenticating, by the controlled medicine dispensing system 10, the user using the PIN received, and determining whether the authenticated user is the patient or a pharmacist.

In certain embodiments, when the pharmacist is authenticated, the method includes: retrieving, by the pharmacist using a computer at a pharmacy, the one or more prescriptions for the patient by one of the one or more physicians from the controlled medicine management system 50 through the communication network 180, unlocking, by the pharmacist, the controlled medicine dispensing system 10, filling/refilling, by the pharmacist, the one or more controlled medicines into the controlled medicine dispensing system 10 according to the prescription retrieved, updating, by the pharmacist, a controlled medicine inventory of the one or more controlled medicines of the controlled medicine dispensing system 10, and locking, by the pharmacist, the controlled medicine dispensing system 10 when the refill is completed.

In certain embodiments, when the patient is authenticated, the method includes: determining, by the controlled medicine dispensing system 10, whether the current time falls into one of predetermined time windows for the patient to take the one or more controlled medicines according to the prescription. When the current time does not fall into one of the predetermined time windows for the patient to take the one or more controlled medicines, the method includes: providing, by the controlled medicine dispensing system 10, no controlled medicine to the patient. When the current time falls into one of the predetermined time windows for the patient to take the one or more controlled medicines according to the prescription, the method includes: providing a dose of the one or more controlled medicines, and updating, by the controlled medicine dispensing system 10, a controlled medicine inventory of the one or more controlled medicines of the controlled medicine dispensing system 10.

In certain embodiments, the method further includes: monitoring the controlled medicine inventory. In certain embodiments, monitoring the controlled medicine inventory includes: recording, by the controlled medicine dispensing system 10, each failed attempt to retrieve the one or more controlled medicines in an activity history base when the user attempts to retrieve the one or more controlled medicines outside of one of the predetermined time windows, transmitting, by the controlled medicine dispensing system 10, related information of the failed attempt to the notification module 1325 to notify certain concerned parties, reviewing, by the controlled medicine dispensing system 10 periodically, the activity history base and determining whether there are any prescription violations recorded, and notifying the prescription violations to the concerned parties.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A controlled medicine dispensing controller of a controlled medicine dispensing system, comprising:
a processor to manage a controlled medicine dispensing system; and
a non-transitory storage device storing an operating system and computer executable instructions, when executed by the processor, the computer executable instructions manage the controlled medicine dispensing system, wherein the computer executable instructions comprise:
a dispenser control module to control a dispenser locking mechanism and a controlled medicine dispensing mechanism;
a notification module to notify a plurality of concerned parties a plurality of activities and status of the controlled medicine dispensing system;
a communication interface module to communicate with a controlled medicine management system through a communication network; and
a keypad user interface module to receive input from a plurality of users through a keypad module, and display the status of the controlled medicine dispensing system through a display module, wherein the plurality of users comprises: at least a patient, and one or more pharmacists.

2. The controlled medicine dispensing controller according to claim 1, wherein the controlled medicine dispensing mechanism dispenses one or more controlled medicines according to a prescription by a physician of the patient prescribed through the controlled medicine management system.

3. The controlled medicine dispensing controller according to claim 1, wherein the dispenser locking mechanism prevents the patient from accessing the one or more controlled medicines outside of a plurality of predetermined time windows according to the prescription.

4. The controlled medicine dispensing controller according to claim 1, wherein the keypad user interface module is configured to
receive a personal identification number (PIN) input from a user to access the controlled medicine dispensing system, wherein the user is either the patient or one of the one or more pharmacists;
authenticate, by the controlled medicine dispensing system, the user through the PIN received;
allow the pharmacist to refill the one or more controlled medicines according to the prescription by the patient's physician, when the user is the one of the one or more pharmacists; and
provide the one or more controlled medicines to the patient through the controlled medicine dispensing mechanism during the plurality of predetermined time windows, when the user is the patient.

5. The controlled medicine dispensing controller according to claim 4, wherein when the pharmacist is authenticated, the pharmacist uses a computer at the pharmacy to retrieve the patient's prescription from the controlled medicine management system, unlocks the controlled medicine dispensing system to refill the one or more controlled medicines according to the patient's prescription retrieved, updates a controlled medicine inventory in the controlled medicine dispensing system, and locks the controlled medicine dispensing system.

6. The controlled medicine dispensing controller according to claim 5, wherein the computer executable instructions are further configured to, when the user is the patient:
determine whether current time falls in one of the plurality of predetermined time windows according to the prescription;
release the one or more controlled medicines according to the prescription, and update the controlled medicine inventory, when the current time falls in one of the plurality of predetermined time windows;
record a failed attempt to retrieve the one or more controlled medicines in an activity history base and transmit related information of the failed attempt to the notification module to notify the plurality of concerned parties, when the current time does not fall in one of the plurality of predetermined time windows; and
review the activity history base, determine whether there are any prescription violations recorded, and notify the prescription violations to the plurality of concerned parties.

7. The controlled medicine dispensing controller according to claim 6, wherein the plurality of concerned parties comprises:
the patient;
the physician;
the one or more pharmacists;
one or more parents or guardians of the patient; and
one or more close friends of the patient.

8. The controlled medicine dispensing controller according to claim 6, wherein one or more events to be notified comprise:
one or more failed attempts to retrieve the one or more controlled medicines;
one or more missed opportunities of taking the one or more controlled medicines during the plurality of predetermined time windows;
one or more prescription violations recorded;
the activity history base;
the controlled medicine inventory; and
the patient has taken a last dose of the one or more controlled medicines.

9. The controlled medicine dispensing controller according to claim 6, wherein the notification of the one or more events comprises:
notification to the plurality of concerned parties with the knowledge of the patient; and
notification to the plurality of concerned parties without the knowledge of the patient.

10. The controlled medicine dispensing controller according to claim 6, wherein the plurality of concerned parties is notified via:
one or more emails;
one or more automatic phone calls;
one or more text messages;
one or more WeChat messages;
one or more Facebook messengers;
one or more WhatsApp messages; and
a plurality of instant messages applications.

11. The controlled medicine dispensing controller according to claim 1, wherein the communication network comprises:
the internet;
a Wi-Fi network;
a local area network (LAN);
a wide area network (WAN);
a personal area network (PAN) having wireless universal serial bus (USB), Bluetooth, Zigbee, Body Area Network (BAN), and Near Field Communication (NFC) network;
a wireless communication network; and
a land line communication network.

12. A computer-implemented method for dispensing one or more controlled medicines using a controlled medicine dispensing system, comprising:
establishing communication between the controlled medicine dispensing system and a controlled medicine management system through a communication network;
registering, at the controlled medicine management system through the communication network, one or more physicians for prescribing one or more controlled medicines, and a plurality of users, and assigning a personal identification number (PIN) for each of the plurality of users, wherein the plurality of users comprises a patient as a primary user of the controlled medicine dispensing system, and one or more pharmacists to fill or refill one or more prescriptions for the patient;
receiving a personal identification number (PIN) from a user through a keypad user interface module of the controlled medicine dispensing system;
authenticating, by the controlled medicine dispensing system, the user through the PIN received;
determining whether the authenticated user is the patient or a pharmacist;
performing one or more of following operations when the user is one of the one or more pharmacists:
retrieving, by the pharmacist using a computer at a pharmacy, the one or more prescriptions for the patient from one of the one or more physicians from the controlled medicine management system through the communication network;
unlocking, by the pharmacist, the controlled medicine dispensing system;
refilling, by the pharmacist, the one or more controlled medicines into the controlled medicine dispensing system according to the prescription retrieved;
updating, by the pharmacist, a controlled medicine inventory of the one or more controlled medicines of the controlled medicine dispensing system; and
locking, by the pharmacist, the controlled medicine dispensing system when the refill is completed; and
performing one or more of following operations, when the user is the patient:
determining, by the controlled medicine dispensing system, whether the current time falls into one of a plurality of predetermined time windows for the patient to take the one or more controlled medicines according to the prescription;
providing, by the controlled medicine dispensing system, no controlled medicines to the patient, when the current time does not fall into one of the plurality of predetermined time windows for the patient to take the one or more controlled medicines;
providing, by the controlled medicine dispensing system, a dose of the one or more controlled medicines when the current time falls into one of the plurality of predetermined time windows for the patient to take the one or more controlled medicines according to the prescription; and
updating, by the controlled medicine dispensing system, the controlled medicine inventory of the one or more controlled medicines of the controlled medicine dispensing system.

13. The computer-implemented method of claim 12, further comprising:
monitoring the controlled medicine inventory.

14. The computer-implemented method of claim 13, wherein monitoring the controlled medicine inventory comprises:
recording, by the controlled medicine dispensing system, each failed attempt to retrieve the one or more controlled medicines in an activity history base when the user attempts to retrieve the one or more controlled medicines outside of one of the plurality of predetermined time windows;
transmitting, by the controlled medicine dispensing system, related information of the failed attempt to a notification module to notify a plurality of concerned parties;
reviewing, by the controlled medicine dispensing system periodically, the activity history base and determining whether there are any prescription violations recorded; and
notifying, by the controlled medicine dispensing system, the prescription violations to the plurality of concerned parties.

15. The computer-implemented method of claim 14, wherein the plurality of concerned parties comprises:
the patient;
the physician;
the one or more pharmacists;
one or more parents or guardians of the patient; and
one or more close friends of the patient.

16. The computer-implemented method of claim 14, wherein one or more events to be notified comprise:
one or more failed attempts to retrieve the one or more controlled medicines;
one or more missed opportunities of taking the one or more controlled medicines during the plurality of predetermined time windows;
one or more prescription violations recorded;
the activity history base;
the controlled medicine inventory; and
the patient has taken a last dose of the one or more controlled medicines.

17. The computer-implemented method of claim 14, wherein the notification of the one or more events comprises:
notification to the plurality of concerned parties with the knowledge of the patient; and
notification to the plurality of concerned parties without the knowledge of the patient.

18. The computer-implemented method of claim 12, wherein the controlled medicine dispensing system comprises a controlled medicine dispensing controller having:
a processor to manage the controlled medicine dispensing system; and
a non-transitory storage device storing an operating system and computer executable instructions, when executed by the processor, the computer executable instructions manage the controlled medicine dispensing system, wherein the computer executable instructions comprise:
a dispenser control module to control a dispenser locking mechanism and a controlled medicine dispensing mechanism;
the notification module to notify a plurality of concerned parties a plurality of activities and status of the controlled medicine dispensing system;
a communication interface module to communicate with a controlled medicine management system through a communication network; and
a keypad user interface module to receive input from the plurality of users through a keypad module, and display the status of the controlled medicine dispensing system through a display module, wherein the plurality of users comprises: at least a patient, and one or more pharmacists.

19. A non-transitory storage device storing computer-executable instructions thereon which, when executed by a processor of a controlled medicine dispensing controller of a controlled medicine dispensing system, cause the processor to perform one or more of following operations of dispensing one or more controlled medicines:
establishing communication between the controlled medicine dispensing system and a controlled medicine management system through a communication network;
registering, at the controlled medicine management system through the communication network, one or more physicians for prescribing one or more controlled medicines, and a plurality of users, and assigning a personal identification number (PIN) for each of the plurality of users, wherein the plurality of users comprises a patient as a primary user of the controlled medicine dispensing system, and one or more pharmacists to fill or refill one or more prescriptions for the patient;
receiving a personal identification number (PIN) from a user through a keypad user interface module of the controlled medicine dispensing system;
authenticating, by the controlled medicine dispensing system, the user through the PIN received;
determining whether the authenticated user is the patient or a pharmacist;
performing one or more of following operations when the user is one of the one or more pharmacists:
retrieving, by the pharmacist using a computer at a pharmacy, the one or more prescriptions for the patient from one of the one or more physicians from the controlled medicine management system through the communication network;
unlocking, by the pharmacist, the controlled medicine dispensing system;
refilling, by the pharmacist, the one or more controlled medicines into the controlled medicine dispensing system according to the prescription retrieved;
updating, by the pharmacist, a controlled medicine inventory of the one or more controlled medicines of the controlled medicine dispensing system; and
locking, by the pharmacist, the controlled medicine dispensing system when the refill is completed; and
performing one or more of following operations, when the user is the patient:
determining, by the controlled medicine dispensing system, whether the current time falls into one of a plurality of predetermined time windows for the patient to take the one or more controlled medicines according to the prescription;
providing, by the controlled medicine dispensing system, no controlled medicines, when the current time does not fall into one of the plurality of predetermined time windows for the patient to take the one or more controlled medicines;
providing, by the controlled medicine dispensing system, a dose of the one or more controlled medicines when the current time falls into one of the plurality of predetermined time windows for the patient to take the one or more controlled medicines according to the prescription;
updating, by the controlled medicine dispensing system, the controlled medicine inventory of the one or more controlled medicines of the controlled medicine dispensing system; and
monitoring the controlled medicine inventory.

20. The non-transitory storage device of claim 19, wherein monitoring the controlled medicine inventory comprises:
recording, by the controlled medicine dispensing system, each failed attempt to retrieve the one or more controlled medicines in an activity history base when the user attempts to retrieve the one or more controlled medicines outside of one of the plurality of predetermined time windows;
transmitting, by the controlled medicine dispensing system, related information of the failed attempt to a notification module to notify a plurality of concerned parties;
reviewing, by the controlled medicine dispensing system periodically, the activity history base and determining whether there are any prescription violations recorded; and
notifying, by the controlled medicine dispensing system, the prescription violations to the plurality of concerned parties.
